(19) United States
(12) Patent Application Publication
(10) Pub. No.: US 2006/0262479 A1
(43) Pub. Date: Nov. 23, 2006

(54) Current control system for electromagnetic actuators

(76) Inventor: Bruce A. Heaston, West Milton, OH (US)

Correspondence Address: DELPHI TECHNOLOGIES, INC., M/C 480-410-202, PO BOX 5052, TROY, MI, 48007, US

(21) Appl. No.: 11/434,950

(22) Filed: May 16, 2006

Related U.S. Application Data
(60) Provisional application No. 60/682,784, filed on May 19, 2005.

(51) Int. Cl. H01H 47/00

(52) U.S. Cl. 361/160

(57) ABSTRACT

A current control system including a load, a power source in selective communication with the load and an energy management regulator adapted to receive electrical energy from the load and transfer the electrical energy to the power source.

This application claims priority from U.S. Ser. No. 60/682,784 filed on May 19, 2005, the entire contents of which are incorporated herein by reference.

### BACKGROUND

Electromagnetic actuators typically include a coil and a controller for controlling the amount of electric current passing through the coil. The current passing through the coil may generate a magnetic flux and the magnetic flux may be proportional to the amount of force generated by the actuator. Therefore, the force generated by an actuator may be controlled by controlling the current passing through the coil, which in turn may be a function of the applied voltage.

Typically, steady state current is controlled using pulse width modulation (“PWM”) techniques. Referring to FIG. 1, a typical PWM control system, generally designated 10, may include a power source 12, a controller 14, a power switch 16 (e.g., a MOSFET switch), a diode 18 and a load 20. The load 20 may consist of an inductive component 22 and a resistive component 24. The power source 12, diode 18 and load 20 each may be connected to ground 26 (e.g., a vehicle chassis).

Accordingly, when the controller 14 actuates the switch 16, current passes from the power source 12, through the switch 16, through the load 20 and back to the power source 12 by way of the ground 26, thereby increasing the current in the load 20 at a positive rate. However, when the switch 16 is de-actuated, current in the inductive component 22 of the load 20 will pass through the resistive component 24, through the diode 18 by way of the ground 26 and back to the inductive component 22, thereby decreasing the current in the load 20 at a negative rate.

As the current in the load 20 decreases, energy is dissipated from the diode 18 as heat, thereby increasing the power consumption of the system 10 and increasing the temperature of the associated controller assembly.

Accordingly, there is a need for a current control system capable of recovering energy and returning the recovered energy to the power source, thereby facilitating a rapid reduction of current in the load. There is also a need for a current control system capable of operating at high frequencies without detriment to the performance of the system

### SUMMARY

In one aspect, a current control system may include a load, a power source in selective communication with the load and an energy management regulator adapted to receive electrical energy from the load and transfer the electrical energy to the power source.

In another aspect, a current control system may include a load in electrical communication with a power source by way of a power switch, a high frequency controller adapted to control the actuation of the power switch and a low pass filter system disposed between the power switch and the load.

In another aspect, a method for controlling a current passing through a load may include the steps of electrically connecting the load to a power source, thereby supplying energy to the load, disconnecting the load from the power source, after the disconnecting step, transferring at least a portion of the energy in the load to a capacitor, and, upon reaching a predetermined voltage across the capacitor, transferring at least a portion of the energy from the capacitor to the power source.

Other aspects of the disclosed current control system will become apparent from the following description, the accompanying drawings and the appended claims.

### BRIEF DESCRIPTION OF THE DRAWINGS

FIG. 1 is a schematic illustration of a prior art control system for an electromechanical actuator;

FIG. 2 is a schematic illustration of one aspect of the disclosed current control system;

FIG. 3 is a schematic illustration of an alternative aspect of the current control system of FIG. 2;

FIG. 4 is a schematic illustration of a second aspect of the disclosed current control system; and

FIG. 5 is a schematic illustration of a third aspect of the disclosed current control system.

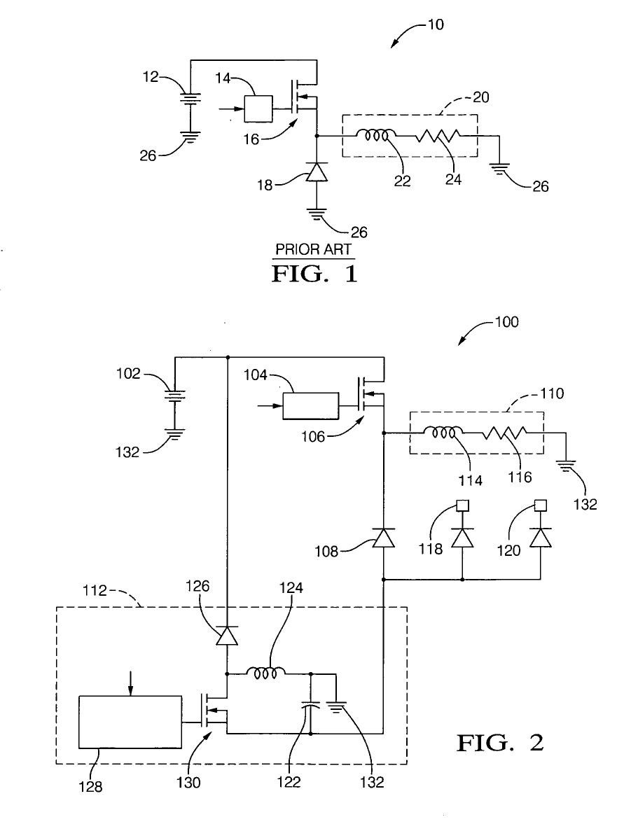

### DETAILED DESCRIPTION

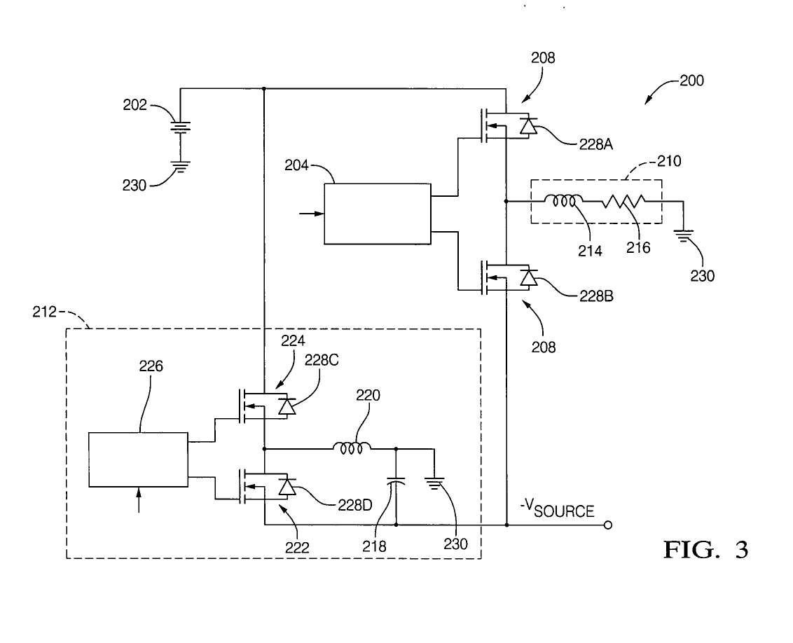

As shown in FIG. 2, one aspect of the disclosed current control system, generally designated 100, may include a power source 102, a controller 104, a power switch 106, a diode 108, a load 110 and an energy management regulator 112. The power source 102 may be a battery or the like, the controller 104 may be PWM controller or the like, the power switch 106 may be a MOSFET switch or the like and the diode 108 may be a free wheeling diode or the like. The load 110 may be the coil of an electromagnetic actuator (not shown) or the like and may include an inductive component 114 and a resistive component 116. Additional loads or output drives 118, 120 may also be provided. The regulator 112 may include a capacitor 122, an inductor 124, a diode 126, a controller 128 and a power switch 130. Controllers 104 and 128 may be separate units or may be associated with a single processor or control unit.

The power source 102, the load 110 and the regulator 112 may be connected to ground 132, such as a vehicle chassis or the like.

The controller 104 may control the power switch 106 to achieve the desired current flow through the load 100. In particular, when the controller 104 actuates the switch 106, current may flow from the power source 102, through the switch 106, through the load 110 and back to the power source 102 by way of the ground 132. However, when the switch 106 is de-actuated, the current in the inductive component 114 of the load 110 may flow through the resistive component 116 of the load 110, to the capacitor 122 by way of the ground 132, then through the diode 108 and back to the inductive component 114. As the current passes through the capacitor 122, the current may charge the capacitor 122, thereby storing energy in the capacitor 122 as a voltage across the capacitor 122.

The voltage V_{Lload} across the inductive component 114 of the load 110 may be represented as follows:
V_{Lload}=I_{load}R_{load}+V_{D}+V_{C} (Eq. 1)
wherein I_{load} is the load current, R_{load} is the resistance of the resistive component 116, V_{D} is the voltage across the diode 108 and V_{C} is the voltage across the capacitor 122. Therefore, as the voltage V_{C} across the capacitor increases, the load current I_{load} may decrease a corresponding amount.

Thus, the capacitor 122 of the regulator 112 may facilitate a faster reduction of load current, thereby facilitating a more robust control response.

As the voltage across the capacitor 122 increases, the controller 128 may determine that a threshold voltage across the capacitor 122 has been reached and may actuate the power switch 130 of the regulator 112 to facilitate the removal of stored energy, thereby reducing the risk of damage to the components of the system 100. In particular, the controller 128 may actuate switch 130 such that current may flow from the capacitor 122, through the inductor 124 and the switch 130 and back to the capacitor 122. However, when the switch 130 is de-actuated, the current in the inductor 124 may flow through the diode 126 and the power source 102 and back to the inductor 124 by way of the ground 132.

Thus, the energy removed from the load 110 when the switch 106 is de-actuated may be recovered and returned to the power source 102 by way of the regulator 112.

As shown in FIG. 3, an alternative aspect of the disclosed current control system, generally designated 200, may be adapted for bidirectional current flow and may include a power source 202, a controller 204, a first power switch 206, a second power switch 208, a load 210 and an energy management regulator 212. The load 110 may be the coil of an electromagnetic actuator (not shown) or the like and may include an inductive component 214 and a resistive component 216. The regulator 212 may include a capacitor 218, an inductor 220, a third power switch 222, a fourth power switch 224 and a controller 226. The power switches 206, 208, 222, 224 may include body diodes 228A, 228B, 228C, 228D.

The power source 202, the load 210 and the regulator 212 may be connected to ground 230, such as a vehicle chassis or the like.

Thus, when switch 206 is actuated, current may flow (e.g., positive current flow) from the power source 202, through the switch 206 and the load 210 and back to the power source 202 by way of the ground 230. When the switch 206 is de-actuated, current may flow from the load 210, to the capacitor 218 by way of the ground 230, through the diode 228B of the switch 208 and back to the load 210, thereby accumulating a voltage across the capacitor 218 such that the node −V_{source} becomes more negative.

When the controller 226 of the regulator 212 determines that the voltage across the capacitor 218 has reached and/or exceeded a predetermined threshold value, the switch 222 may be actuated such that current may flow from the capacitor 218, through the inductor 220 and back to the capacitor 218 by way of the switch 222. When the switch 222 is de-actuated, the current may flow from the inductor 220, through the diode 228C of the switch 224, to the power source 202 and back to the inductor 220 by way of the ground 230, thereby returning energy recovered by the regulator 212 to the power source 202.

An opposite current flow may be achieved by actuating switch 208 such that current may flow from the capacitor 218, through the load 210 by way of the ground 230, through the switch 208 and back to the capacitor 218 by way of the node −V_{source}, thereby decreasing the voltage across the capacitor 218. When switch 208 is de-actuated, the current may flow from the load 210, through the diode 228A of the switch 206, through the power source 202 and back to the load 210 by way of the ground 230.

The switch 224 may be actuated such that current may flow from the power source 202, through the switch 224 and the inductor 220 and back to the power source 202 by way of the ground 230. When the switch 224 is de-actuated, current may flow from the inductor 220, through the capacitor 218 and the diode 228D of the switch 222 and back to the inductor 220, thereby accumulating a voltage across the capacitor 218.

Thus, the voltage of the node −V_{source} may be controlled by controlling the actuation and de-actuation of switches 206, 208, 222, 224, which may facilitate the recovery and return of electrical energy to the power source 202, while facilitating bidirectional current flow.

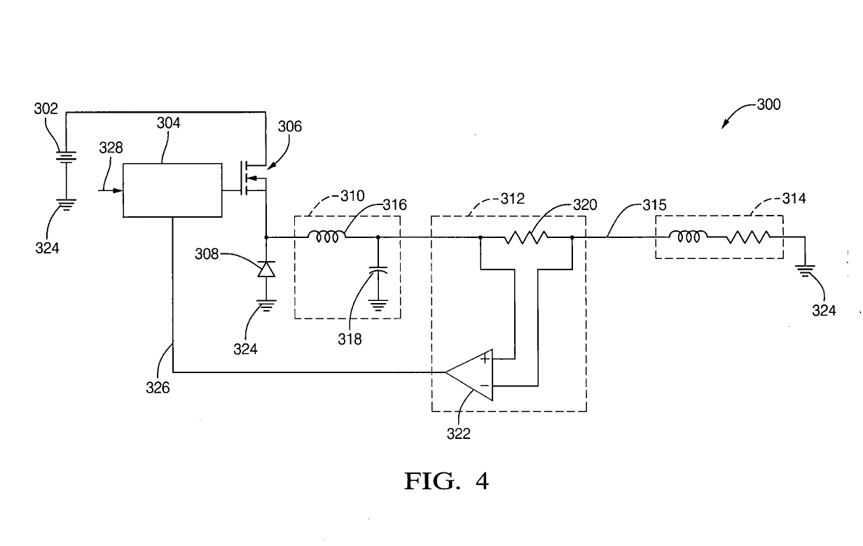

As shown in FIG. 4, another aspect of the disclosed current control system, generally designated 300, may include a power source 302, a controller 304, a power switch 306, a diode 308, a low pass filter system 310, a current feedback system 312 and a load 314. The power source 302, diode 308 and load 314 may be connected to ground 324.

The current feedback system 312 may include a sense resistor 320 and an amplifier 322, such as a differential amplifier or the like. The amplifier 322 may detect a voltage drop across the resistor 320 and may communicate a corresponding current signal to the controller 304 (e.g., by way of communication line 326). Therefore, the controller 304 may generate a control signal for controlling the switch 306 based upon an input command 328 and current feedback 326 from the current feedback system 312. In one aspect, the controller 304 may operate at high frequencies, such as about 50 to about 150 kHz, for example.

The low pass filter system 310 may include an inductor 316 and a capacitor 318 and may be adapted to filter high frequency signals. In one aspect, the low pass filter system 310 may reduce the bandwidth of the signals that reach the sense resistor 320 and ultimately the load 314. For example, filtered signals may have a frequency of about 0 to about 5 kHz.

Thus, by incorporating the low pass filter 310, the controller 304 may be a high frequency controller (e.g., a high frequency PWM controller) and may control the switch 306 at a high frequency without some or all of the disadvantages (e.g., EMC problems) associated with a high frequency signal passing through the wire harness 315, which may be relatively long, to the load 314.

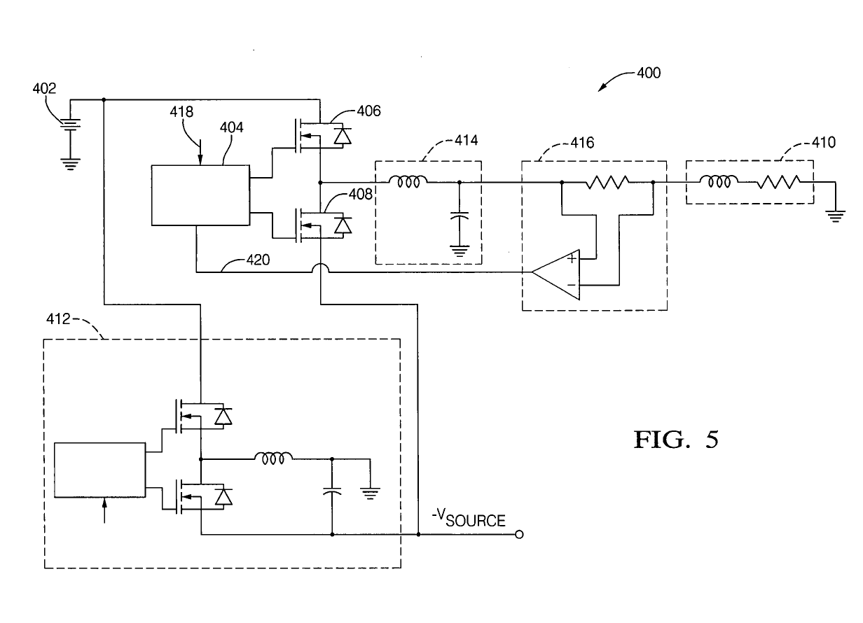

Referring to FIG. 5, an alternative aspect of the current control system illustrated in FIG. 3, generally designated 400, may include a power source 402, a controller 404, a first power switch 406, a second power switch 408, a load 410, an energy management regulator 412, a low pass filter system 414 and a current feedback system 416.

Thus, the system 400 may achieve bidirectional current flow, as described above, in response to an input signal 418 and a current feedback signal 420 from the current feedback system 416. Furthermore, the energy management regulator may facilitate the recovery and return of electrical energy to the power supply. Still furthermore, with the addition of the low pass filter system 414, the controller 404 may operate the switches 406, 408 at a high frequency without negative downstream effects.

Although various aspects of the disclosed current control system have been shown and described, modifications may occur to those skilled in the art upon reading the specification. This application includes such modifications and is limited only by the scope of the claims.

What is claimed is:

1. A current control system comprising:
a load;
a power source in selective communication with said load; and
an energy management regulator adapted to receive electrical energy from said load and transfer said electrical energy to said power source.

2. The system of claim 1 wherein said load is a coil of an electromechanical actuator.

3. The system of claim 1 wherein said power source is a battery.

4. The system of claim 1 further comprising at least one power switch disposed between said power source and said load.

5. The system of claim 4 further comprising a controller for controlling the actuation of said power switch.

6. The system of claim 5 wherein said controller is a high frequency pulse width modulation controller.

7. The system of claim 6 further comprising a low pass filter disposed between said power switch and said load.

8. The system of claim 7 wherein said low pass filter includes at least one inductor and at least one capacitor.

9. The system of claim 5 further comprising a current feedback system disposed between said power switch and said load, said current feedback system being in communication with said controller.

10. The system of claim 1 wherein said energy management regulator includes at least one capacitor, at least one inductor and at least one power switch.

11. The system of claim 10 wherein said electrical energy from said load is adapted to be transferred to said capacitor when said load is not in electrical communication with said power source.

12. The system of claim 11 wherein said energy management regulator is adapted to transfer electrical energy transferred to said capacitor from said load to said power source.

13. The system of claim 1 wherein said power source is adapted to generate a bidirectional current through said load.

14. A current control system comprising:
a load in electrical communication with a power source by way of a power switch;
a controller adapted to control the actuation of said power switch; and
a low pass filter system disposed between said power switch and said load.

15. The system of claim 14 wherein said load is a coil of an electromechanical actuator.

16. The system of claim 14 wherein said controller is a high frequency pulse width modulation controller.

17. The system of claim 14 wherein said low pass filter system includes at least one inductor and at least one capacitor.

18. The system of claim 14 wherein said controller is adapted to communicate a control signal to said power switch, wherein said control signal has a frequency of about 50 to about 150 kHz.

19. The system of claim 14 further comprising a current feedback system disposed between said power switch and said load, wherein said current feedback system is in communication with said controller.

20. A method for controlling a current passing through a load comprising the steps of:
electrically connecting said load to a power source, thereby supplying energy to said load;
disconnecting said load from said power source;
after said disconnecting step, transferring at least a portion of said energy in said load to a capacitor; and
upon reaching a predetermined voltage across said capacitor, transferring at least a portion of said energy from said capacitor to said power source.
